(19) United States
(12) Patent Application Publication
(10) Pub. No.: US 2013/0088513 A1
(43) Pub. Date: Apr. 11, 2013

(54) Fun Videos and Fun Photos

(71) Applicant: ArcSoft Inc., Fremont, CA (US)

(72) Inventor: Hui Deng, San Ramon, CA (US)

(73) Assignee: ARCSOFT INC., Fremont, CA (US)

(21) Appl. No.: 13/649,088

(22) Filed: Oct. 10, 2012

Related U.S. Application Data
(60) Provisional application No. 61/545,574, filed on Oct. 10, 2011.

(51) Int. Cl. G09G 5/00

(52) U.S. Cl. 345/629

(57) ABSTRACT

A method for a computing device to provide a video includes receiving one or more selections of one or more animated facial effects to be applied to a face in a photo, automatically detecting the face in the photo, generating the video by applying the one or more selected animated facial effects to the face, displaying the video, and saving the video or a frame of the video.

### CROSS-REFERENCE TO RELATED APPLICATION

This application claims the benefit of U.S. Provisional Application No. 61/545,574, filed Oct. 10, 2011.

### DESCRIPTION OF RELATED ART

Consumers often use smart phones to capture photos. There is a need for entertaining applications for manipulating the captured photos.

### BRIEF DESCRIPTION OF THE DRAWINGS

In the drawings:

FIG. 1 is a block diagram of a mobile device with a fun video application;

FIG. 2 is a flowchart of a method executed by a processor of the mobile device in FIG. 1 to create a fun video;

FIGS. 3 and 4 are screenshots of a graphic user interface provided by the processor in FIG. 1 to create a fun video; and

FIG. 5 is a photo annotated with movements for facial feature points, all arranged according to embodiments of the present disclosure.

Use of the same reference numbers in different figures indicates similar or identical elements.

### DETAILED DESCRIPTION

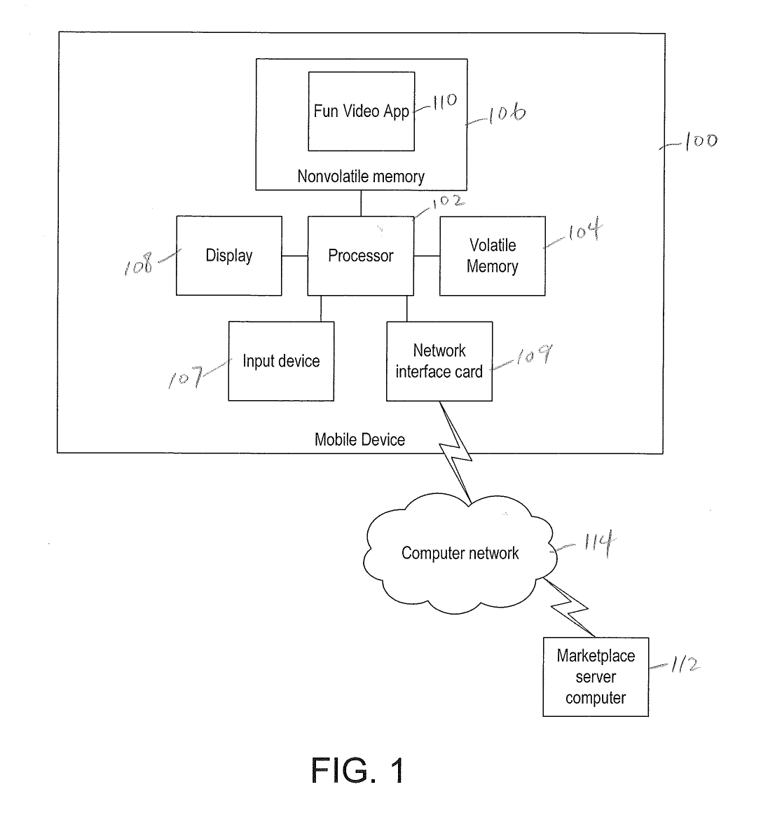

FIG. 1 is a block diagram of a computing device 100 in one or more embodiments of the present disclosure. Computing device 100 may be a mobile device, such as a smart phone like the iPhone® or a tablet computer like the iPad®. Computing device 100 includes a processor 102, a volatile memory 104, a nonvolatile memory 106, an input device 107, a display 108, and a network interface card 109. Processor 102 loads the code for a fun video (“fundeo”) application 110 from nonvolatile memory 106 to volatile memory 104, executes the code, and stores application data in the volatile memory. Fundeo application 110 allows a user to apply one or more facial effects to a person's face in a photo. A facial effect may be animated so the user sees the transition of the face from an initial state to a final state. For example, a facial effect may change a facial expression (e.g., making a surprised face), change facial features (e.g., extending one's nose), add new facial features (such as adding a beard), or add special cartoon effects (e.g., bulging eye balls or morphing into an alien head shape).

Executing the code for fundeo application 110, processor 102 provides a graphical user interface (GUI) on display 108 and receives user input from input device 107. Using the GUI, a user selects a photo having a person's face and selects facial effects to be applied to the photo. In response, processor 102 automatically generates a fundeo where the facial effects are applied sequentially to the photo. The user may select to save the fundeo as a video file. Processor 102 generates a funny photo (“funto”) when only one facial effect is selected, and the user may select to save the funto as an image file.

Fundeo application 110 may initially provide a number of standard facial effects. A server computer 112 hosts a marketplace or a store on a computer network 114 where the users of fundeo application 110 can download additional facial effects for a price or free. The facial effects may be sold individually or provided as a subscription service where the users receive new facial effects each month. Free facial effects may come with ads that are displayed to the users, such as during the download of the facial effects or as banner ads within fundeo application 110. Server computer 112 also takes submissions of facial effects from independent vendors to give to or sell to the users of fundeo application 110.

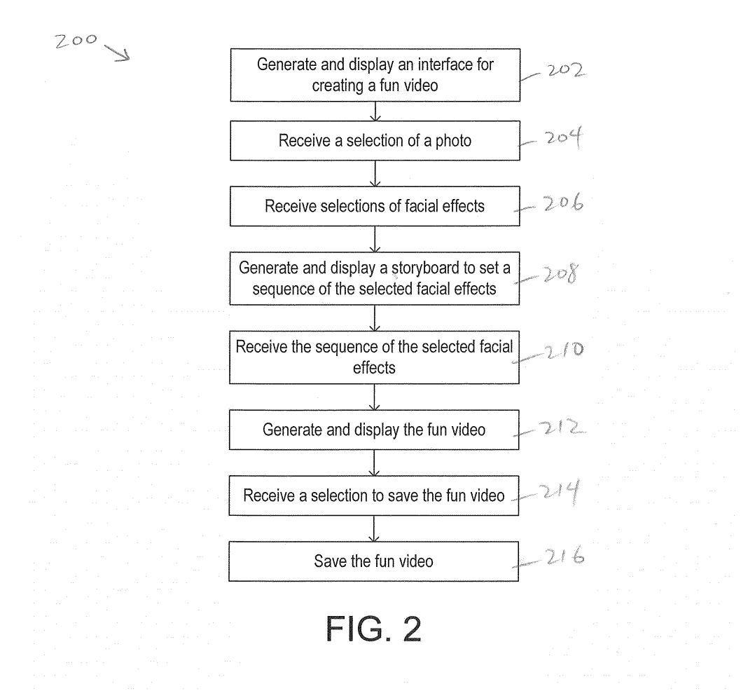

FIG. 2 is a flowchart of a method 200 implemented by fundeo application 110 (FIG. 1) and executed by processor 102 (FIG. 1) to create a fundeo or funto in one or more embodiments of the present disclosure. Method 200 may include one or more operations, functions, or actions illustrated by one or more blocks. Although the blocks are illustrated in sequential orders, these blocks may also be performed in parallel, and/or in a different order than those described herein. Also, the various blocks may be combined into fewer blocks, divided into additional blocks, and/or eliminated based upon the desired implementation. Method 200 may begin in block 202.

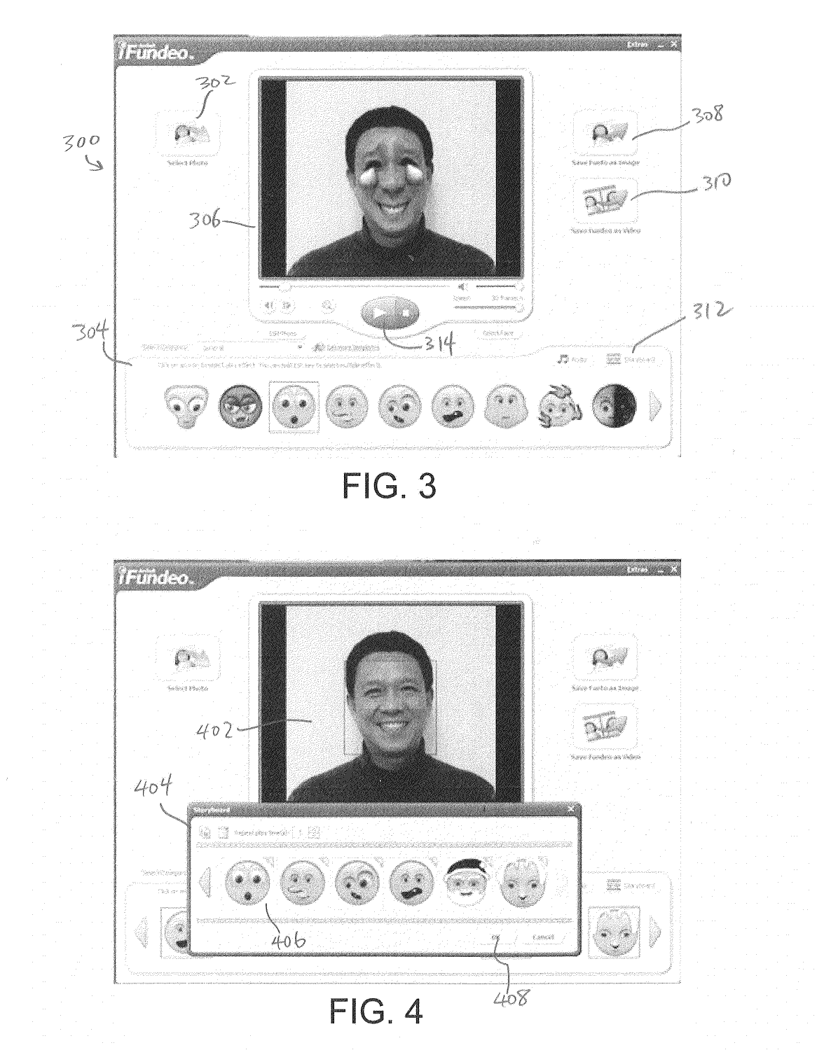

In block 202, processor 102 generates and displays the GUI for fundeo application 110. FIG. 3 illustrates a GUI 300 for fundeo application 110 in one or more embodiments of the present disclosure. GUI 300 includes a select photo button 302, an effects panel 304, a playback area 306, a save funto as image button 308, and a save fundeo as video button 310. To create a fundeo or funto, the user typically first selects a photo by clicking select photo button 302. In response, processor 102 provides a file browser for the user to select the photo. Assume the user selects a photo 402 (FIG. 4). Referring back to FIG. 2, block 202 may be followed by block 204.

In block 204, processor 102 receives the selection of photo 402 (FIG. 4). Next, the user typically selects one or more facial effects to be applied to selected photo 402 by clicking on their icons in effects panel 304 (FIG. 3). As discussed above, the user may download additional facial effects from a marketplace hosted by server computer 112 (FIG. 1) for a price or free. These facial effects may be from the maker of fundeo application 110 or from independent vendors. For free facial effects, processor 102 may display ads during the download of the facial effects or during the use of fundeo application 110. Block 204 may be followed by block 206.

In block 206, processor 102 receives selections of the facial effects. The user then typically sets the sequence of the selected facial effects. To do this, the user clicks a storyboard button 312 (FIG. 3) in effects panel 304 (FIG. 3). Block 206 may be followed by block 208.

In block 208, in response to the clicking of storyboard button 312, the processor 102 generates and displays a storyboard with the selected facial effects. FIG. 4 shows a storyboard 404 with selected facial effects 406 (only one is labeled) in one or more embodiments of the present disclosure. The use is able to drag and drop facial effects 406 to arrange their sequence. The user clicks an OK button 408 to accept the sequence of selected facial effects 406. Referring back to FIG. 2, block 208 may be followed by block 210.

In block 210, processor 102 receives the sequence of selected facial effects 406 (FIG. 4). The user then typically selects a play button 314 (FIG. 3) in playback area 306 (FIG. 3) to view the resulting fundeo or funto. Note that blocks 208 and 210 are optional when the user selects only a single facial effect. Block 210 may be followed by block 212.

In block 212, processor 102 generates and displays the fundeo or funto. Processor 102 first detects a face in selected photo 402 (FIG. 4) and then detects points about facial features such as the eye brows, the eyes, the nose, and the mouth. Processor 102 may automatically detect the face and the facial feature points without any human input. Human input may be used to refine the automatically detected face and facial feature points. Methods for detecting a face and facial feature points (also called “key points”) are disclosed in U.S. Pat. Nos. 7,643,659, 7,953,253, and 7,751,599, which are commonly assigned and incorporated by reference.

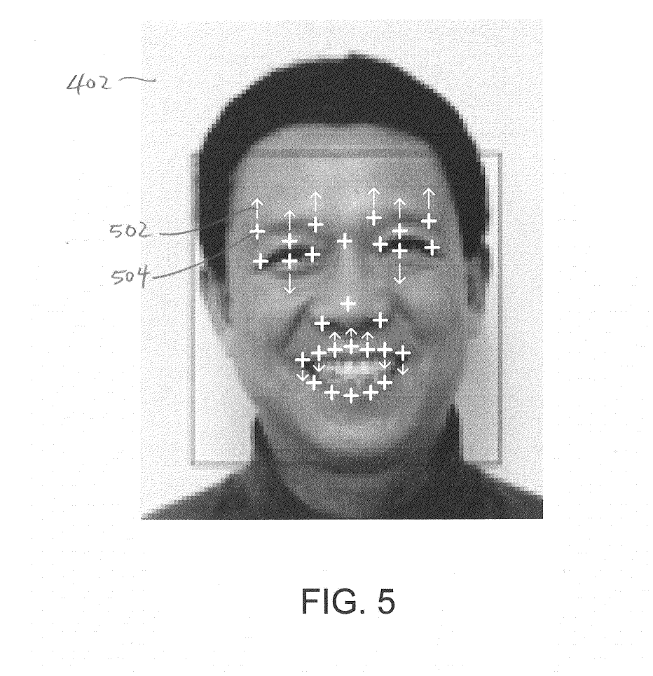

Processor 102 may manipulate the facial feature points and their neighboring pixels to achieve a desired facial effect. For example, assume the user selects to create a surprised facial expression. To create this effect, processor 102 may move the pixels that make up the eye brows to raise the eye brows, shape the pixels that make up the eyes to create a wide-eyed effect, and shape the pixels that make up the mouth to make an open mouth. This is done gradually over several frames to create an animated effect. FIG. 5 illustrates movements 502 (only one is labeled) of the facial feature points 504 (only one is labeled) in photo 402 to create the surprised facial expression in one or more embodiments of the present disclosure.

Instead of moving pixels, processor 102 may replace them with new pixels to create a desired facial effect. For example, assume the user selects to create the bulging eye balls effect, processor 102 may replace the pixels that make up the eye with a series of cartoon animation of bulging eye balls. A method for replacing a facial feature is disclosed in U.S. Pat. No. 7,796,787, which is commonly assigned and incorporated by reference.

For the next facial effect, processor 102 may revert to the original photo and apply the next facial effect. Alternatively processor 102 may apply the next facial effect based on the current positions of the facial feature points. Block 212 may be followed by block 214.

After viewing the fundeo or funto, the user typically selects to save the funto or fundeo by clicking save funto as image button 308 or save fundeo as video button 310. In block 214, processor 102 receives a selection of save funto as image button 308 or save fundeo as video button 310. Block 214 may be followed by block 216.

In block 216, processor 102 saves the funto as an image or the fundeo as a video.

Various other adaptations and combinations of features of the embodiments disclosed are within the scope of the present disclosure. For example, fundeo application 110 may also run on a laptop or desktop computer. Numerous embodiments are encompassed by the following claims.

What is claimed is:

1: A method for a computing device to provide a video, comprising:
receiving one or more selections of one or more animated facial effects to be applied to a face in a photo;
automatically detecting, by a processor, the face in the photo;
generating, by the processor, the video by applying the one or more selected animated facial effects to the face;
displaying the video; and
saving the video or a frame of the video.

2: The method of claim 1, wherein applying the one or more selected animated facial effects comprises performing each selected animated facial effect gradually over multiple frames to create an animated effect.

3: The method of claim 2, wherein generating the video comprises:
detecting, by the processor, facial feature points on the face; and
applying the one or more selected animated facial effects to the face based on the facial feature points on the face.

4: The method of claim 1, further comprising:
displaying a storyboard for setting a sequence of the one or more selected animated facial effects; and
receiving the sequence of the one or more selected animated facial effects, wherein generating the video comprises applying the one or more selected animated facial effects in the sequence to the face.

5: The method of claim 1, further comprising displaying an advertisement.

6: The method of claim 5, further comprising downloading an additional animated facial effect from a server computer over a computer network.

7: The method of claim 6, wherein the advertisement is displayed during downloading the additional animated facial effect.

8: A non-transitory computer-readable medium comprising instructions for a processor to provide a video, the instructions comprising:
receiving one or more selections of one or more animated facial effects to be applied to a face in a photo;
automatically detecting the face in the photo;
generating the video by applying the one or more selected animated facial effects to the face;
displaying the video; and
saving the video or a final frame of the video.

9: The non-transitory computer-readable medium of claim 8, wherein applying the one or more selected animated facial effects comprises performing each selected animated facial effect gradually over multiple frames to create an animated effect.

10: The non-transitory computer-readable medium of claim 9, wherein generate the video comprises:
detecting, by the processor, facial feature points on the face; and
applying the one or more selected animated facial effects to the face based on the facial feature points on the face.

11: The non-transitory computer-readable medium of claim 8, wherein the instructions further comprise:
displaying a storyboard for setting a sequence of the one or more selected animated facial effects; and
receiving the sequence of the one or more selected animated facial effects, wherein generating the video comprises applying the one or more selected animated facial effects in the sequence to the face.

12: The non-transitory computer-readable medium of claim 8, wherein the instructions further comprise displaying an advertisement.

13: The non-transitory computer-readable medium of claim 12, wherein the instructions further comprise downloading an additional animated facial effect from a server computer over a computer network.

14: The non-transitory computer-readable medium of claim 13, wherein the advertisement is displayed during downloading the additional animated facial effect.
